(19) United States
(12) Patent Application Publication
(10) Pub. No.: US 2017/0021871 A1
(43) Pub. Date: Jan. 26, 2017

(54) LIGHTWEIGHT STRUCTURAL JOINER

(71) Applicant: NEW ENGLAND WHEELS, INC., Billerica, MA (US)

(72) Inventors: Anjani Kumar, Nashua, NH (US); Miteshkumar Hasmukhlal Patel, Nashua, NH (US); Paul LaRose, Mansfield, MA (US)

(73) Assignee: NEW ENGLAND WHEELS, INC., Billerica, MA (US)

(21) Appl. No.: 14/806,730

(22) Filed: Jul. 23, 2015

(51) Int. Cl. B62D 31/02; B62D 27/02; C09J 5/00; B62D 25/02

(52) U.S. Cl. CPC B62D 31/02; B62D 25/02; B62D 27/026; B62D 27/023; C09J 5/00

(57) ABSTRACT

A structural joiner including one or more box beams disposed between inner and outer arcuate surfaces and methods of assembling are described. The extrusions delineate various channels for structural considerations. In an implementation, the joiner may be implemented on a multi-passenger vehicle, such as a bus.

### FIELD

The present disclosure generally relates to mechanisms for joining structures, and more particularly to an improved joiner and methods of making and installing the joiner.

### BACKGROUND

Typically, multi-passenger buses and other vehicles are constructed of a frame onto which panels are attached (as illustrated in FIGS. 1A through 1B). These vehicles, since they carry passengers that often do not wear restraints such as seatbelts, are subject to rigorous safety and crash test standards.

The vehicle frame is often a rigid structure made of a metal (such as steel) and the panels are often aluminum or fiberglass. Since the frame is rigid and the panels are made of malleable, brittle materials, a crash or rollover of the vehicle often results in the panels deforming and the frame breaking, causing serious injury to passengers. As a result, present multi-passenger vehicles contain limited residual space (i.e., a survival zone for passengers) within the passenger compartment of the bus or vehicle (illustrated in FIGS. 2 through 4B).

Reinforcement structures have been implemented to increase the structural integrity of known frames and panels. For example, steel plates or another heavy, durable material is appended to the frame and/or panels to increase their structural integrity. However, these reinforcement techniques cause the multi-passenger vehicles to become excessively heavy, creating issues regarding Gross Vehicle Weight and fuel economy

### SUMMARY

In general, the present disclosure relates to a structural joiner including box beams for joining sidewall panels and a roof of a multi-passenger bus or like vehicle, and methods for making and installing/using the structural joiner. The light weight, durable structural joiner and a method of construction include one or more box beams disposed interior to at least one extrusion having inner and outer arcuate surfaces. The joiner may be formed as inner and outer extrusions that are assembled together with box beams interior thereto.

The box beam(s), which may be hollow or solid cross-section of insulating material that can create a thermal barrier between inner and outer arcuate surface, or which may be pultrusion(s), while adding structural integrity to the joiner, also serve to create a thermal barrier between the inner and outer arcuate surfaces. In order to provide a structural joiner that satisfies and/or exceeds required impact and strength considerations, pultruded box beams may be disposed in parallel locations in relation to one another within the joiner.

Space between the inner and outer arcuate surfaces or extrusion(s), and/or within the box beams may be used as a conduit to route lines, such as electrical lines, within the joiner, and/or a filler material may be disposed in the internal space(s). The filler material may impart further structural integrity to the joiner and/or may provide other desirable properties, such as a thermal insulation, vibration damping, or the like. For example, the filler material may be disposed in a central channel between the inner and outer surfaces/extrusions.

### BRIEF DESCRIPTION OF THE DRAWINGS

Embodiments of devices, systems, and methods are illustrated in the figures of the accompanying drawings which are meant to be exemplary and not limiting, in which like references are intended to refer to like or corresponding parts, and in which:

FIG. 1A-1B illustrate a perspective view of a known multi-passenger vehicle according to the prior art;

FIG. 2 illustrates a cross-section view of a present multi-passenger vehicle according to the prior art;

FIGS. 3A and 3B illustrate a cross-section view of a known multi-passenger vehicle according to the prior art;

FIGS. 4A and 4B illustrate a perspective view of a known multi-passenger vehicle according to the prior art;

FIG. 5 illustrates a perspective view of a passenger compartment of a multi-passenger vehicle constructed using a structural joiner according to the present disclosure;

FIG. 6 illustrates a cross-section view of a passenger compartment of a multi-passenger vehicle constructed using a structural joiner according to the present disclosure taken along line A-A of FIG. 5;

FIG. 7A illustrates a cross-sectioned view of a structural joiner according to the present disclosure;

FIG. 7B illustrates an exploded view of a structural joiner according to the present disclosure;

FIG. 7C illustrates a perspective view of a 1-piece extruded joiner according to the disclosure;

FIG. 7D illustrates a cross-sectioned view of a structural joiner according to the present disclosure; and

FIG. 8 illustrates a block flow diagram illustrating a method of assembling a structural joiner according to the present disclosure.

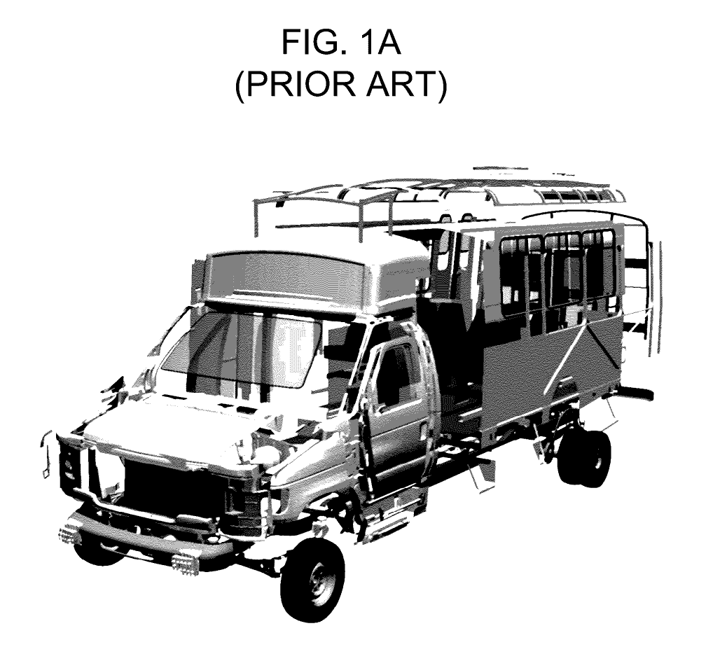

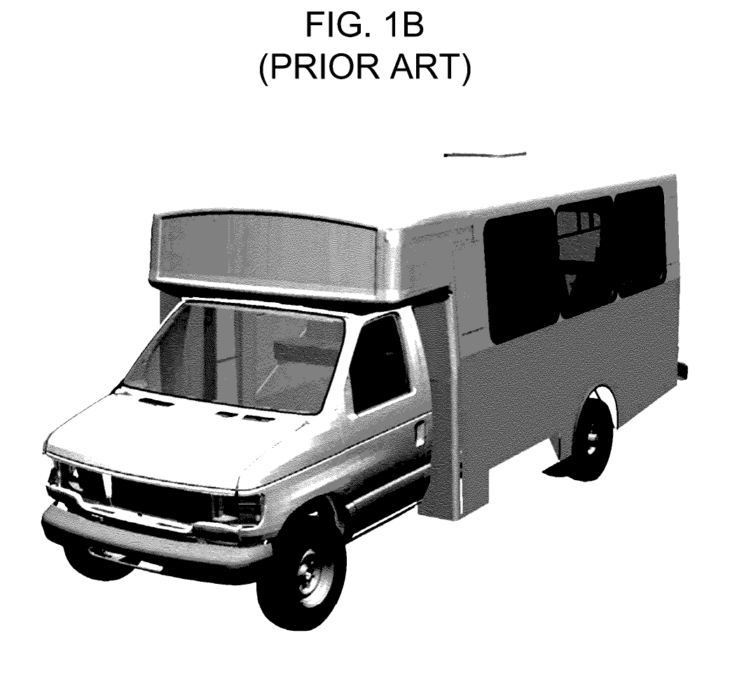

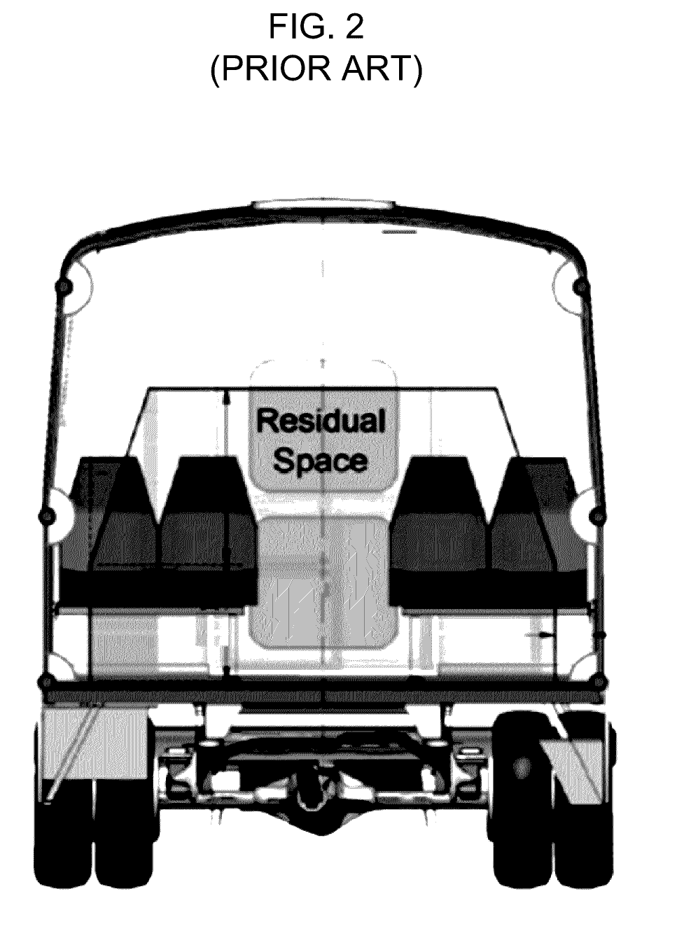

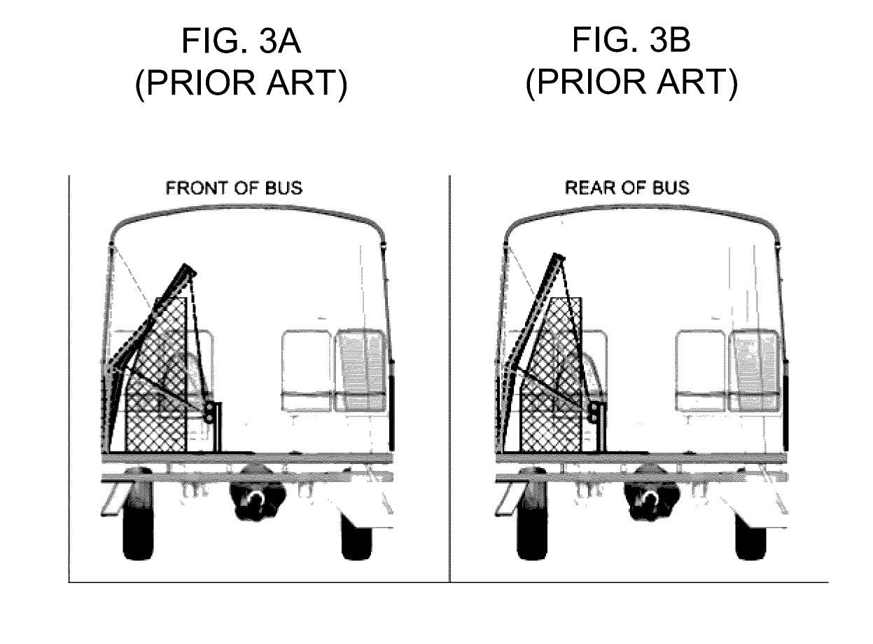

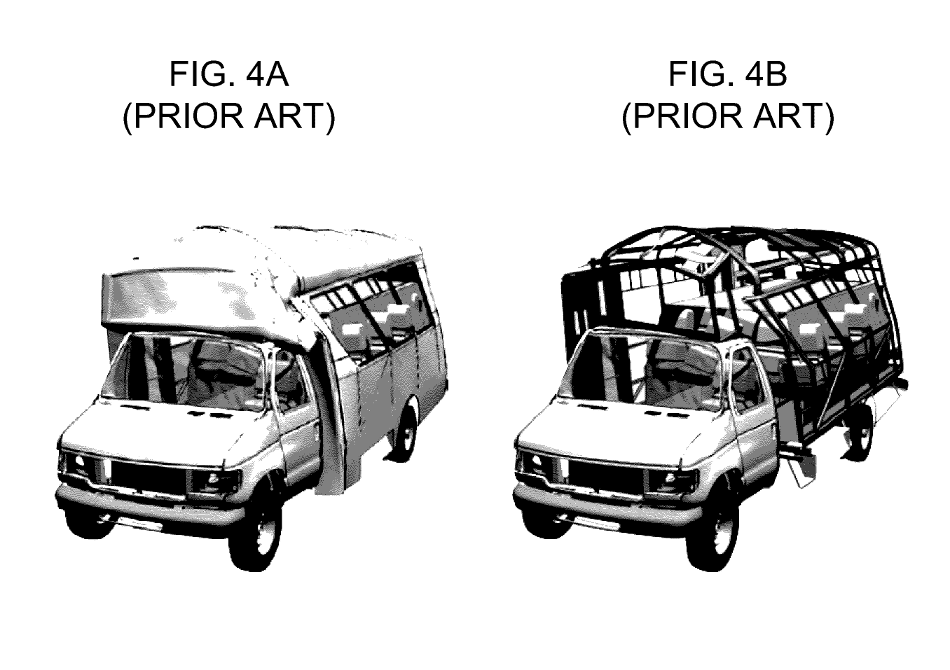

### DETAILED DESCRIPTION

Detailed embodiments of devices, systems, and methods are disclosed herein, however, it is to be understood that the disclosed embodiments are merely exemplary of the devices, systems, and methods, which may be embodied in various forms. Therefore, specific functional details disclosed herein are not to be interpreted as limiting, but merely as a basis for the claims and as a representative basis for teaching one skilled in the art to variously employ the present disclosure.

In general, the present disclosure relates to a light weight, durable structural joiner and a method of construction including one or more box beams disposed interior to at least one extrusion having inner and outer arcuate surfaces. The joiner may be formed as a single extrusion into which box beams are installed, or it may not be formed as inner and outer extrusions that are assembled together with box beams interior thereto. The term “box beam” as used herein should not be limited to a construction of having four equal length perpendicular sides, but rather should be construed to have any cross-section shape sufficient to perform the functions and characteristics disclosed herein. One or both of the inner and outer extrusions may be constructed using anodized aluminum, steel, fiberglass pultrusion, or the like.

The box beams may be created using a pultrusion process, which includes pulling fiberglass reinforcements through a bath of thermosetting resin and into a heated forming-and-curing die to produce composite structural shapes. Thus, the box beams may be constructed of a pultruded combination of fiberglass reinforcements and polyester or vinyl ester resin, with the combination being thermoset. An example of such a box beam is sold under the trade name EXTREN® by Strongwell Corporation. The box beams, or pultrusions, while adding structural integrity to the joiner, also serve to create a thermal barrier between the inner and outer arcuate surfaces. In order to provide a structural joiner that satisfies and/or exceeds required impact and strength considerations, the pultruded box beams may be disposed in parallel locations in relation to one another within the joiner.

A filler material may also be disposed between the inner and outer arcuate surfaces or extrusions, and/or within the box beams. The filler material may impart further structural integrity to the joiner and/or may provide other desirable properties, such as a thermal insulation, vibration damping, or the like. For example, the filler material may be disposed in a central channel between the inner and outer surfaces/extrusions.

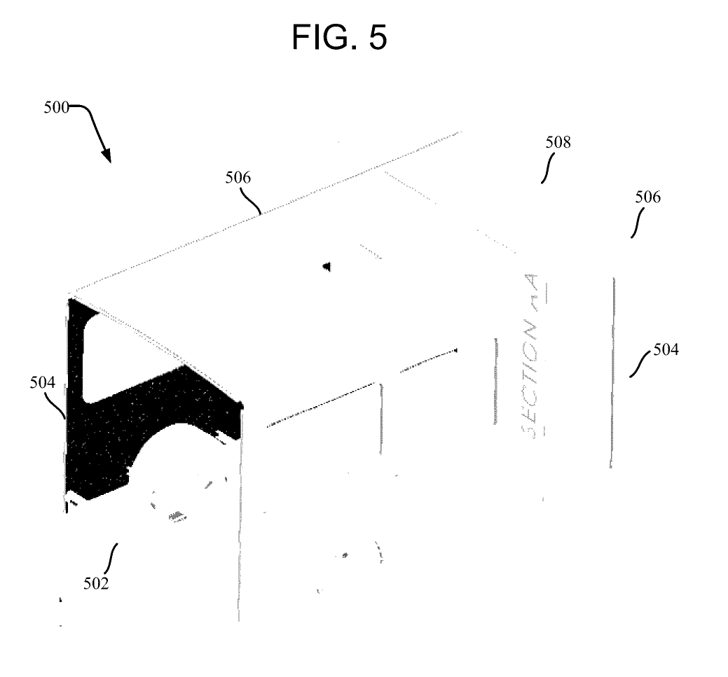

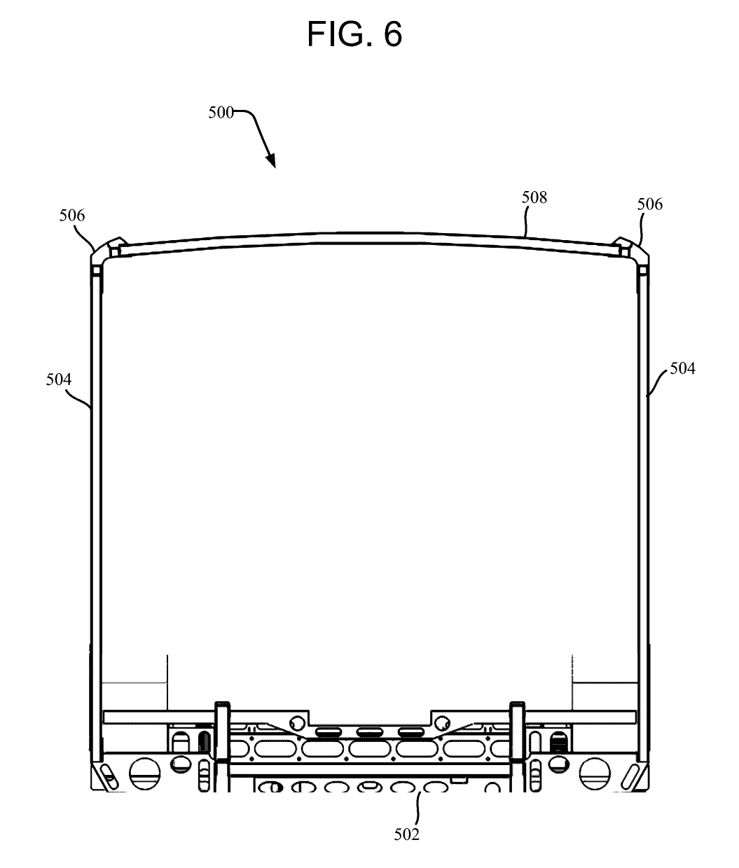

FIGS. 5 and 6 illustrate a passenger compartment 500 of a multi-passenger bus or vehicle assembled using a structural joiner according to the present disclosure. The passenger compartment 500 is assembled using a chassis 502 and, side panels 504 that are each coupled to the chassis 502. Structural joiners 506, according to the disclosure, are each coupled to an end f the side panel 504 distal to the end of the side panel coupled to the chassis 502. A roof panel 508 is coupled to the structural joiners 506 to form a modular vehicle body. As illustrated, each structural joiner 506 spans the length (front to back and vice versa) of the passenger compartment 500. However, one skilled in the art should appreciate that the structural joiners 506 may not have lengths commensurate in scope with the entire length of the passenger compartment 500. In an example, each structural joiner 506 may have a length shorter than that of the passenger compartment 500, thereby resulting in more than one structural joiner 506 being used on each side of the passenger compartment 500 in order to cover the length of the passenger compartment 500.

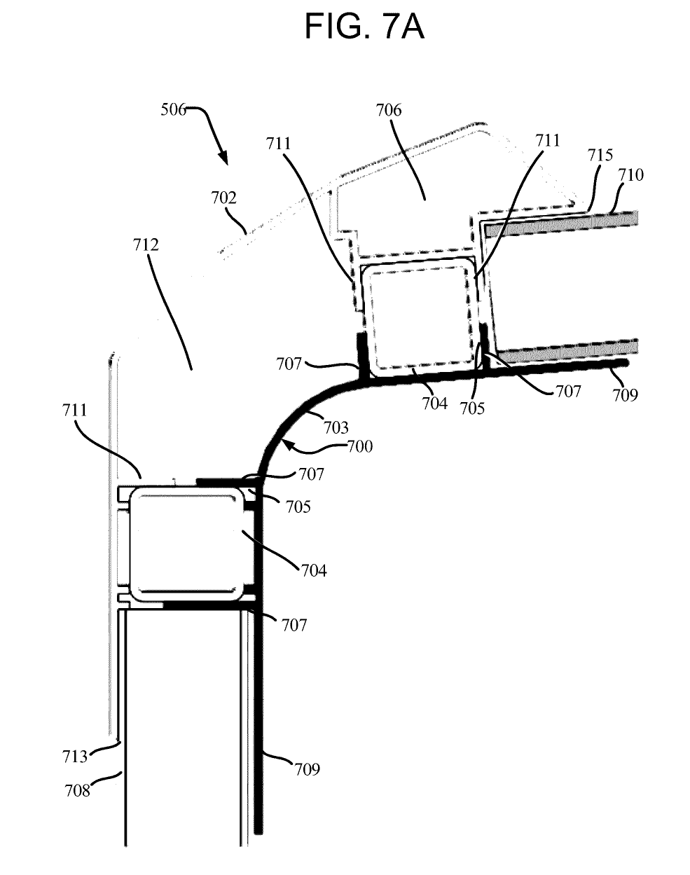

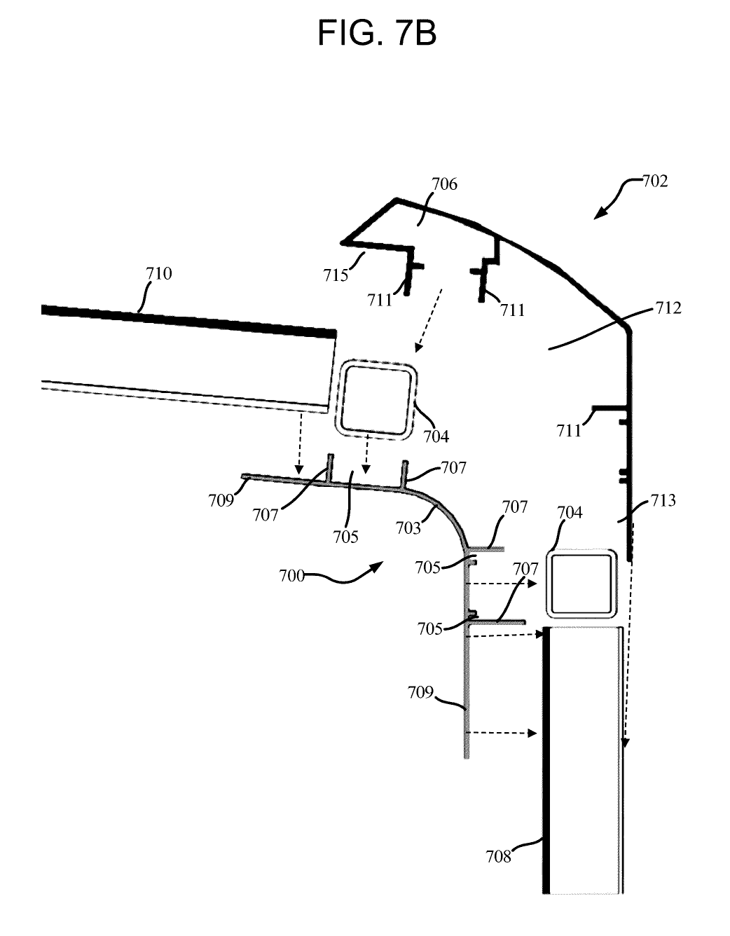

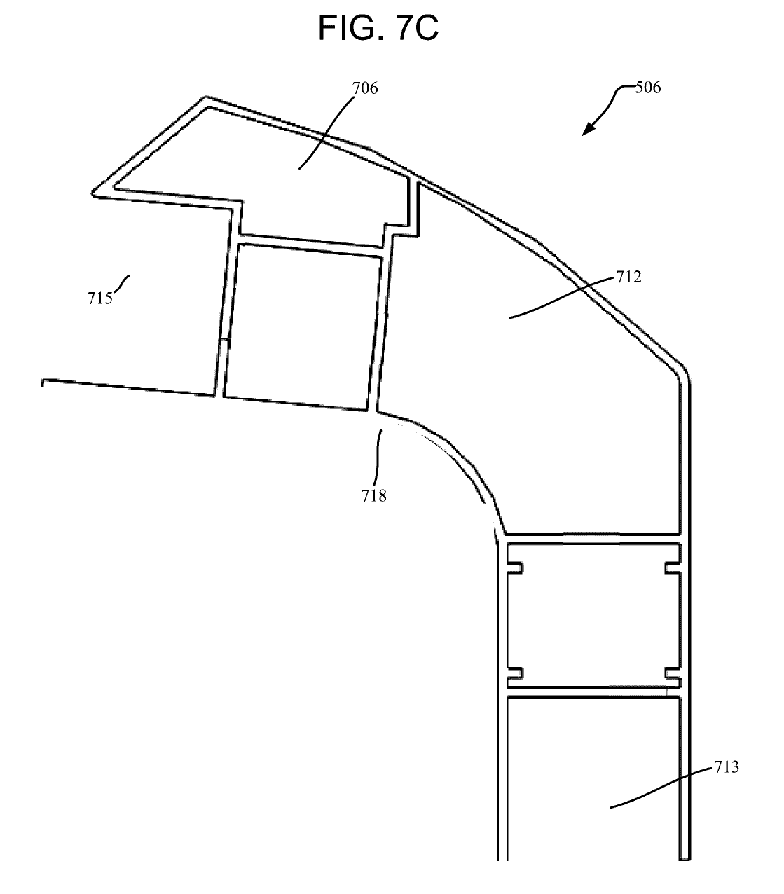

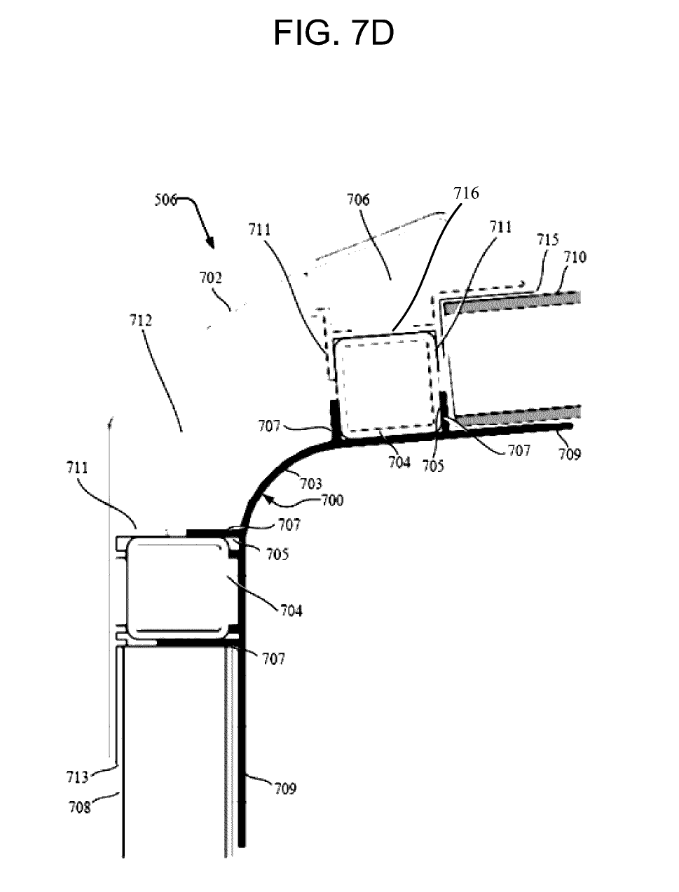

FIGS. 7A through 7C illustrate a cross-section of the structural joiner 506 according to the present disclosure. The joiner 506 in this illustrative embodiment includes an inner extrusion 700, an outer extrusion 702, and one or more box beams 704. The inner and outer extrusions 700, 702 may be coated, embossed, laminated, or otherwise provide decorative appeal to the exterior and/or interior of the joiner 506.

The inner extrusion 700 is an arcuate structure having an arcuate or curved surface 703 that is convex with respect to an inner passenger compartment when implemented. Furthermore, one or more support channels 705 are created along the curved surface by walls 707 that extend from the curved surface. For example, these walls may extend substantially perpendicularly from the curved surface. Moreover, the curved surface may have at least one substantially linear or planar surface 709 from which the walls extend. One or more box beam channels may be created by the walls proximate to ends of the curved surface. Additionally, a sidewall panel channel is described further hereinafter created proximate to or at an end of the curved surface and a roof channel is created proximate or at a different end of the curved surface. One or both of the sidewall panel and roof channels may be partially created by the curved surface and partially created by a wall of a respective box beam channel.

The outer extrusion 702 in this illustrative embodiment, like the inner extrusion 700, is also an arcuate structure having an arcuate or curved surface that is convex with respect to an inner passenger compartment when implemented. As illustrated, the arcuate surface of the outer extrusion 702 is not a uniform curve (it may contain one or more bends). However, one skilled in the art should appreciate that the arcuate surface of the outer extrusion 702 may be substantially or perfectly arcuate without departing from the scope of the present disclosure. A rigid channel 706 may be defined within or proximate to an end of the outer extrusion 702, which forms a conduit that allows cables, wires or lines, such as air conditioning lines, and the like to be routed or passed through the joiner 506. Walls 711 extend from the curved surface and/or rigid channel to create a sidewall panel channel 713, roof channel 715, and one or more box beam channels. These walls may extend perpendicularly from the curved surface and/or rigid channel, for example. Each of the one or more box beam channels formed by walls 711 houses one or more box beams 704. At least one of the box beam channels may be created by walls proximate to ends of the curved surface.

The sidewall panel channel 713 is created proximate to or at an end of the curved surface and the roof channel 715 is created proximate to or at a different end of the curved surface. One or both of the sidewall panel and roof channels 713, 715 may be partially created by the curved surface and/or a wall of a respective box beam channel. A portion of the rigid channel 706 may be used to create either a portion of the roof channel 715 or a portion of the sidewall panel channel 713, or the rigid channel 706 may not be used in the construction of either the sidewall panel channel or roof channel, for example. Moreover, a portion of the rigid channel 706 may be used to partially create one or more of the box beam channels for housing box beams 704.

The one or more box beams 704 may be formed using a pultrusion process known in the art, which includes pulling fiberglass reinforcements through a bath of thermosetting resin and into a heated forming-and-curing die to produce composite structural shapes. Thus, the box beams 704 may be constructed of a pultruded combination of fiberglass reinforcements and polyester or vinyl ester resin, with the combination being thermoset. An example of such a box beam 704 is sold under the trade name EXTREN® by Strongwell Corporation. The box beams 704 may provide corrosion resistance, low thermal conductance, low electrical conductance, electromagnetic transparency, light weight, high strength, fire resistance, and/or dimensional stability to the joiner 506, for example. The box beams 704 may be any hollow or solid cross-section of insulating material capable of creating a thermal barrier between the inner and outer extrusions 700, 702. The box beams 704 could be dimensioned to be 0.75 inch by 3.5 inch square beams to provide desired strength and weight characteristics. Furthermore, the box beams 704 may be used to pass cables, lines, and the like through the joiner 506. The one or more box beams 704 may be disposed in selected locations within the box beam channels of the inner and outer extrusions 700, 702 to provide necessary weight, strength, and structural integrity to the joiner 506. Thus, each box beam 704 may have a length substantially equal to or identical to the length of the structural joiner 506, resulting in a single box beam 704 being implemented within each box beam channel. However, one skilled in the art should appreciate the box beams 704 having different lengths resulting in one or more box beam 704 being implemented within a single box beam channel.

Unassembled, the box beam, sidewall panel, and roof channels of the inner and outer extrusions 700, 702 each only partially house the box beam(s) 704, sidewall panel 708, and roof 710. When assembled, these channels of the inner extrusion 700 correspond with respective channels of the outer extrusion 702 to fully encapsulate or house the box beams(s) 704, and engage portions of sidewall panels 708, and portions of the roof 710. All or some of the channels (that is the box beam, sidewall panel, roof, and rigid channels) may run parallel or substantially parallel to each other along their respective extrusion 700, 702.

As illustrated in FIGS. 7A and 7B, the structural joiner 506 is constructed of two separate and distinct extrusions 700, 702. However, as illustrated in FIG. 7C the structural joiner 506 may be constructed of a single unitary extrusion that resembles and has features largely corresponding to and described with respect to the two extrusions 700, 702 coupled together. An adhesive 718 may be layered along an inner surface of the single unitary extrusion. This adhesive 718 may be designed as an insulator and may be comprised of foam, for example. Also, when a single unitary extrusion is implemented, the box beams 704 may be omitted. Regardless of the construction, a channel 712 is formed between the two arcuate surfaces. This channel 712 may be used to pass materials through the joiner 506, such as cables, refrigerant lines, and the like, for example. Similarly, box beam channels are formed to receive one or more box beams 704. Likewise, a sidewall panel channel 713 and roof channel 715 are formed to receive portions of a sidewall panel 504 and a roof panel 504, respectively.

Coupling of the inner and outer extrusions 700, 702, when not a single unitary structure, may include ensuring respective channels of the extrusions 700, 702 (such as box beam-box beam, roof-roof, etc.) substantially correspond or line up with each other. Moreover, coupling of the extrusions 700, 702 may include the use of an adhesive, epoxy, resin, fasteners or like light weight, durable material.

In an exemplary implementation, the rigid channel 706 has a wall containing a hole/opening 716 therethrough (illustrated in FIG. 7D). In an example, the hole/opening 716 is located through a wall of the rigid channel 706 proximate a box beam 704.

While not illustrated, a filler material may be disposed within the channels of the inner and outer extrusions 700, 702 or within the single extrusion. The filler material may impart further structural integrity to the joiner and/or may act as a thermal insulator. For example, the filler material may be disposed in the channels that house the box beams 704 in a way that either completely fills the channel, forms a barrier between the channel walls and the box beams 704, and/or fills the box beams 704. The filler material may be a fluid, a foam, or other lightweight, durable material.

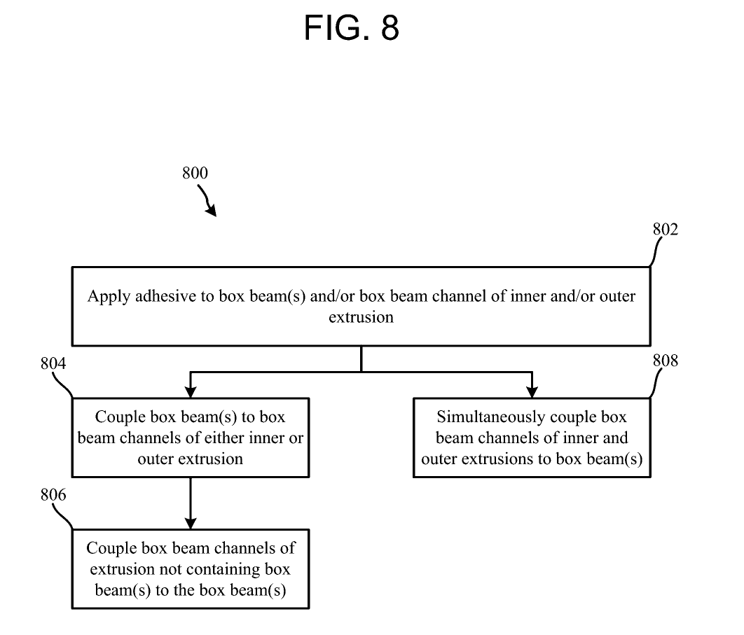

FIG. 8 illustrates a method 800 of making/assembling the extrusions 700, 702 according to the present disclosure. At block 802 an adhesive is applied to one or more box beam(s) and/or box beam channels of an inner and an outer extrusion. At block 804 the box beam(s) are placed within/coupled to the box beam channels of either the inner or outer extrusion. At block 806 the box beam channels of the extrusion (either inner or outer) not containing the box beams(s) are coupled to the box beam(s). Alternatively, the box beam channels of respective inner and outer extrusions may be coupled to the box beam(s) simultaneously (illustrated as block 808).

The above embodiments of the present disclosure are meant to be illustrative. They were chosen to explain the principles and application of the disclosure and are not intended to be exhaustive or to limit the disclosure. Many modifications and variations of the disclosed embodiments may be apparent to those of skill in the art. Moreover, it should be apparent to one skilled in the art, that the disclosure may be practiced without some or all of the specific details and steps disclosed herein.

The concepts disclosed herein may be applied within a number of different devices and systems, including, for example, vehicles, watercraft, residential construction, commercial construction, etc. The specification and drawings are, accordingly, to be regarded in an illustrative rather than a restrictive sense. It should, however, be evident that various modifications and changes may be made thereunto without departing from the broader spirit and scope of the disclosure as set forth in the claims.

1. A structural joiner, comprising:
an inner arcuate surface having extensions;
an outer arcuate surface coupled to the inner arcuate surface, the outer arcuate surface having extensions corresponding with the extensions of the inner arcuate surface to provide channels; and
beams extending through at least one of the channels.

2. The joiner of claim 1, wherein one of the channels houses a portion of a sidewall panel.

3. The joiner of claim 1, wherein one of the channels houses a portion of a roof.

4. The joiner of claim 1, wherein the beams are formed by a pultrusion or extrusion process.

5. The joiner of claim 1, wherein the outer arcuate surface has a rigid channel proximate an end of the outer arcuate surface.

6. The joiner of claim 1, wherein at least one of the inner arcuate surface and the outer arcuate surface is formed by an extrusion process.

7. The joiner of claim 1, wherein a filler material is disposed within at least one of the channels.

8. The joiner of claim 1, wherein the inner arcuate surface and the outer arcuate surface are formed as a single piece.

9. A method of making a structural joiner, comprising the steps of:
applying an adhesive to at least one of box beam channels of an inner arcuate surface and box beams;
coupling the box beams to the box beam channels of the inner arcuate surface;
applying an adhesive to at least one of the box beams and box beam channels of an outer arcuate surface; and
coupling the box beams to the box beam channels of the outer arcuate surface.

10. The method of claim 9, further comprising:
aligning ends of the box beams with ends of inner arcuate surface prior to coupling the box beam to the inner arcuate surface.

11. The method of claim 9, further comprising:
coupling ends of a plurality of box beams together prior to coupling the plurality of box beams to the inner arcuate surface.

12. The method of claim 11, wherein the plurality of box beams have a length substantially identical to a length of the box beam channels of the inner arcuate surface.

13. The method of claim 9, wherein the box beam has a cross-section length in the range of about 0.75 inches to about 3.5 inches.

14. A structural joiner, comprising:
beams;
an inner arcuate surface having inner beam channels, the inner beam channels being coupled to substantially half of a surface area of the beams; and
an outer arcuate surface having outer beam channels, the outer beam channels being coupled to substantially half of the surface area of the beams.

15. The joiner of claim 14, wherein each of the beams has a length substantially equal to lengths of the inner and outer arcuate surfaces.

16. The joiner of claim 14, wherein the beam channels of the inner and outer arcuate surfaces are located proximate edges of the inner and outer arcuate surfaces.

17. The joiner of claim 14, wherein at least one of the beam channels of the inner and outer arcuate surfaces couples to more than one beam.

18. The joiner of claim 14, wherein each of the beams has a cross-section length of about 0.75 inches to about 3.5 inches.

19. The joiner of claim 14, wherein the outer arcuate surface has a rigid channel, the rigid channel having an aperture located through a wall thereof.

20. The joiner of claim 19. wherein the wall having the aperture located there through is proximate an outer beam channel of the outer arcuate surface.
